(19) United States
(12) Patent Application Publication
(10) Pub. No.: US 2010/0102569 A1
(43) Pub. Date: Apr. 29, 2010

(54) Worldwide wind farm enclosure units and grid: worldwide battery-based airflow induced wind farm enclosure units and grid (webbaidwindfarm)

(76) Inventor: William Marshall Pickard, III, Montgomery, AL (US)

Correspondence Address: William Marshall Pickard ll, P.O. Box 70697, Montgomery, AL, 36107-0697, US

(21) Appl. No.: 12/290,092

(22) Filed: Oct. 27, 2008

(51) Int. Cl. F03D 9/00

(52) U.S. Cl. 290/55

(57) ABSTRACT

A system for producing energy from the flow of air by providing a source of energy which provides power to operate an airflow generating device directly through mechanical energy, or by generating electrical current that charges a grid of one or more batteries, backed up by other sources of energy in the event that the primary source of energy fails to provide sufficient energy to keep the batteries charged. The batteries provide power to an airflow generating device such as a wind turbine or fan placed in an enclosure, which produces a flow of air which powers a plurality of wind energy generators situated in this same enclosure so that these wind generators operate at maximum airflow speeds specified by the wind/airflow energy generators for optimal production of energy without damage to the generator units, thus producing power for numerous purposes including power for homes, commercial and other uses, to supply net excess power generated to worldwide power grids, and to provide energy for the operation of all types of vehicles.

### CROSS-REFERENCE TO RELATED APPLICATIONS

None

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to the production of energy from an airflow produced by a device in an enclosure.

2. Prior Art

There is no prior art in which an external source of energy is employed to power an airflow producing device in an enclosure which activates wind generators also mounted within the enclosure each of which generates energy, primarily electrical current.

3. Objects and Advantages

Accordingly, several objects and advantages of the invention (also referred to as the “Webbaidwindfarm”) are:

(1) to solve the major problem regarding wind energy (intermittent and unreliable wind speeds occurring naturally in the environment) by providing a consistently generated airflow at peak air speeds calibrated to produce the highest, optimal air speed for maximum output of energy by wind generators per unit specification for each wind generator.

(2) to provide a constant source of energy by which to activate the airflow producing device within the enclosure through mechanical energy or electrical current energy.

(3) in the case of electrical current energy, the constant source of energy which activates the airflow producing device within the enclosure is supported through a battery grid, which consists of 1 or more batteries which provide(s) a constant source of power to the airflow generating device.

(4) to solve the problem of intermittent wind flow in the natural environment by producing an airflow utilizing a airflow producing device, such as a wind turbine or fan, powered by a battery charged by an energy source such as solar or hydrogen power, and/or other auxiliary sources of power, including back-up sources of power.

(5) to optimize the volume of power produced by placing the airflow producing device and multiple wind generators in an enclosure which can vary widely in dimensions and which can contain the airflow and magnify the strength of the airflow through the “venturi effect” by which the enclosure narrows from the source of the airflow towards the other end of the enclosure. The airflow producing device generates the airflow at optimal airflow speeds in order to produce the highest amount of power from the wind generators according to their capacity without damage to the wind generators. The wind generators are placed in optimal positions facing said airflow producing device in order to be activated at said optimal speeds (production of electrical energy is exponentially increased by increase in airflow speed).

(6) to provide for and enhance the advantages of wind/airflow power production, including improvements in all areas of energy transportation, including greatly reduced energy transportation costs.

(7) to increase the advantages, incentives, and profits for commercial entities, including utilities and commercial entities presently involved in energy issues (including oil and gas companies), regarding a large scale investment in the manufacture, installation and ongoing maintenance of Webbaidwindfarm units in existing and future power grids.

(8) to greatly enhance local, regional and national infrastructure by government or privately sponsored and financed installation of independent, stand alone Webbaidwindfarm units in isolated locations where interconnection to a power grid would be impractical, cost prohibitive or otherwise not commercially attractive or viable.

(9) to decrease if not eliminate dependence on non-renewable energy resources, especially fossil fuels, by using renewable energy sources, such as solar and hydrogen based energy, to the greatest extent practicable to power the airflow producing device which activates the wind generators in the enclosure, and/or to charge the battery system which powers the airflow generating device which creates the airflow to power the wind generators in the enclosure. Other renewable energy resources may also be used.

(10) to diversify and greatly improve the current energy grid system by establishing a massive number of energy generating units which can produce energy independently or in connection to an energy grid.

(11) to provide energy generators in isolated locations which are not connected to an energy grid and which otherwise would not have such a source of energy/power. This invention provides the means to establish an energy generating source at virtually any location worldwide which can provide energy independently or connected to a utility grid.

(12) to greatly improve and enhance current energy grids by providing this massive number of energy generating units, many of which will generate more power than consumed at the location of these units. Through net metering, this excess energy can be re-directed back to the energy grid to be used where needed.

(13) to minimize the need for non-renewable energy resources to power worldwide energy grids.

(14) to greatly reduce the impact of naturally occurring extreme weather events, such as floods, high wind thunderstorms, tornados, hurricanes, and other such conditions, by providing localized energy generating devices that can operate independently as independent power generating units with or without connection to a power grid, and by designing the enclosures and components to be resistant to damage due to such extreme weather events.

(15) to conserve energy resources through the use of renewable energy (e.g.: solar, hydrogen power), and thus to materially enhance and improve the quality of humankind by contributing to the restoration or maintenance of life sustaining natural elements, primarily air quality and reduction in carbon emissions and content in the air and atmosphere, as further described below.

(16) by providing a way to use energy more efficiently thereby also conserving natural resources, and by greatly reducing energy transmission and transportation costs (especially since energy is generated on location where consumed).

(17) by increasing production and consumer savings by reducing the cost of energy, e.g.: per kilowatt hour, by producing energy through said renewable energy resources which involve primarily the cost and maintenance of the apparatus and which have minimal or no cost regarding the fuel or resource to power the apparatus. Costs will further be reduced by the stability of power production by this invention over time, where there are no significant factors (such as increasing costs of fossil fuels for other present energy production methods) which increase in cost over time. Reduction in energy transportation costs is a massive advantage, since billions of dollars have been spent and are currently proposed to be spent on the cost of transporting energy current from more remote areas where naturally occurring wind speeds are high but the energy must be transported over long distances to population areas where energy is needed. This energy transportation cost will be virtually eliminated by comprehensive installation of Webbaidwindfarm units.

(18) to create jobs and reduce unemployment by establishing manufacturing plants which will assemble and produce the invention and items related to the invention, and which will create other businesses and jobs which will support such efforts or otherwise thrive due to this industry, by establishing installation and service entities to install and maintain the units and by generating related businesses and jobs.

(19) to reduce environmental pollution, particularly air, land and water pollution, due to the non-polluting operation and efficiency of Webbaidwinfarm units and by reducing with the goal of eliminating effluents in the air and waterways from conventional power plants. Thermal and other pollution of such air and waterways will be reduced so that air and water quality will be maintained and will actually be restored due to natural self-purification.

(20) to enhance environmental quality by absence of GHG (greenhouse gases) emissions, absence of sulfur dioxide or nitrogen oxide omissions or acid rain, no mining, drilling, or other extraction of fuel, no toxic, radioactive or harmful wastes, no use of water for steam or cooling (except in isolated cases where water or steam may be used for a source of energy to power the airflow generating device), and by decreasing the wind/airflow energy footprint by concentrating the airflow energy production devices in space efficient and minimally obstructive enclosures.

(21) to provide an efficient, self-contained energy generating unit that will provide minimal or no impact regarding environmental factors including harm to birds, bats, and other avian or airborne animals, reduced disruption of habitats for prairie grouse, grassland songbirds, and other animals in areas where larger wind towers are being erected.

(22) to eliminate the consequences of ice throw from rotor blades of conventional wind generators not contained in an enclosure, and from falling debris from conventional wind generators mounted on towers, rooftops, or other higher areas, due to extreme weather, malfunctioning, aging of the devices, or other causes for such conventional wind generators to break down resulting in falling debris from the units.

(23) to increase safety for utility repair personnel since smaller, localized wind generator units are designed to detect power outages and shut down automatically in such cases until serviced by utility personnel, and they do not energize dead power lines due to the safety features of net meters. Webbaidwindfarm units which are stand-alone, independent units not connected to a grid are not connected to utility lines, thus posing no risk to utility repair personnel.

(24) to produce hydrogen through facilitating the operation of hydrogen-generating electrolyzers which can be used as a renewable fuel for energy production and other uses, including fuel to propel land, air and aquatic vehicles.

(25) to provide great increase in the capacity of power grids through massive quantity of interconnections of Webbaidwindfarm units which produce net energy which is supplied through net metering to these grids.

(26) to provide the means to enhance wind/airflow and hydro integration, wind/airflow farm data monitoring, wind/airflow power integration systems, economic impacts, and other macro effects of massive quantity installations of Webbaidwindfarm units.

(27) to reduce insurance costs associated with wind/airflow energy production due to the elimination of many casualty risks (such as wind tower collapse, collision, personal injury and other risks) and the greatly increased safety features of the Webbaidwindfarm units, which will result in significantly reduced insurance premiums.

(28) to minimize visual impacts which can have negative practical as well as aesthetic consequences, including lessened aesthetic landscape effects which can impact tourism and residential or commercial development, and to eliminate “shadow flicker” effects from conventional wind generators which are not placed in any enclosure.

(29) to increase aviation safety by elimination of wind generator towers, which are obviated by the airflow generating devices in enclosures which can be placed in virtually any location, and do not require a tower to gain access or greater access to airflow.

(30) to eliminate the need to construct towers on which to place wind generators and the regulatory issues that often apply to erection of towers, and to increase general public safety by elimination of wind generator towers are a source of injury to children and other persons who trespass and particularly those who climb and fall from these towers.

(31) to reduce health care costs by reducing or eliminating the causes of many health problems, including premature deaths, such those caused by pollutants from fossil fuel and nuclear based energy production plants.

(32) to reduce erosion caused by placement of conventional wind generators and their towers in areas prone to the effects of erosion caused by such installations

(33) to propel land, water and air vehicles using Webbaidfindfarm units by providing high production of energy utilizing exceptionally small spaces when needed for said enclosure, which not only helps the environment, but allows for placement of as many such units as needed for specific purposes including mobile units in vehicles. The small space requirement also allows for usage in vehicles that operate over land, in the air, and on and under water.

(34) to provide immediate reduction of dependence on fossil fuels and other non-renewable sources of energy production with the goal of elimination of the use of these fuels.

(35) to eliminate and replace nuclear energy as a source of energy, and hazardous nuclear waste materials.

(36) to greatly reduce with the goal of eliminating pollution including carbon and other emissions, hazardous wastes, and other negative impacts on the environment caused by other methods of production of energy, thus greatly improving environmental quality.

(37) to counter terrorism by (a) creating a massive number of energy generating units which can operate independently and would not be directly vulnerable to an attack on a major energy generating source, (b) reducing the impact of an attack on major energy generating sources and grids by the ability of these units to operate independently, (c) greatly reducing the amount of funds spent on purchasing foreign fuels used to generate energy domestically, particularly in the cases where the funds are paid to foreign countries who are identified as hostile to the United States and other countries, and particularly those who have been identified as countries who provide financial, technical and/or other assistance to terrorists or who otherwise sponsor terrorism, (d) providing massive amounts of energy enabling the federal government to maintain, increase and defer usage of other national energy fuel reserves for use in the case of national emergencies, including terrorist attacks.

(38) to enhance domestic security by providing the impetus for massive manufacturing efforts to produce Webbaidwindfarm units for local and worldwide use, massive commercial efforts to procure and install said units locally and worldwide, and massive continuous enterprises, increased employment opportunities, significant economic growth, and other positive economic factors associated with manufacturing, maintaining and servicing the Webbaidwindfarm units locally and worldwide.

(39) to provide power for any other sources, such as water or other pumps, which require power production.

### SUMMARY

In accordance with the invention, an external source or sources of energy (e.g.: solar, hydrogen cell) provide power to charge a battery grid, which provide electrical current to operate an airflow generating device, such as a fan or turbine, situated at one end of an enclosure. External sources of mechanical energy can also directly operate the airflow generating device. A plurality of wind generators are placed in the enclosure at optimal positions. The airflow generating device produces airflow speeds at the maximum speed to produce the greatest amount of energy pursuant to the optimal operating speed specified for the wind generators. Auxiliary sources of energy are provided to charge the battery grid in the event that the primary external source of energy should fail to sustain sufficient battery charging. An electronic controller governs the flow of energy by ensuring that a constant flow of energy is produced to power the airflow generating device by switching automatically to the interconnected energy grid or other back up external energy sources when necessary to maintain sufficient predetermined energy to this device. The energy produced can provide large amounts of electricity or other power for consumption as needed by homes, businesses, vehicles, pumps, and other objects or entities. The energy produced by the invention units can be interconnected through net metering to power grids throughout the world.

### DRAWINGS—FIGURES

FIGS. 1A and 1B represent external sources of mechanical energy or electrical current energy (e.g. from solar panels, photovoltaic cells, hydrogen-cell powered generator, fossil fueled generator, etc.).

FIG. 2 shows an enclosure containing batteries, FIG. 2B, which are charged by the wind generators and which provide current to the airflow generating device (FIG. 3B), and which are continually charged by the external source of energy (FIG. 1). This enclosure can be made waterproof to avoid damage during floods and wind resistant to avoid airflow damage from severe weather.

FIG. 3 shows an enclosure, which contains the airflow generating device (FIG. 3B) and a plurality of wind generators (FIGS. 3C-3K). This enclosure can be cylindrical and can narrow from the FIG. 3B side to the FIGS. 3J and 3K side to provide a venturi effect.

FIGS. 3C to 3K represent a plurality of wind generators producing energy as a result of the airflow generated by the airflow generating device (FIG. 3B). The plurality of wind generators is predetermined by factors described below.

FIG. 4 shows an electrical regulator and rheostat control panel which includes power output meters to confirm the power output of each airflow generating device in the enclosure (FIG. 3). The electronic regulator and rheostat is connected to the electronic controller (FIG. 2A) and the net meter (FIG. 6) which supplies excess energy produced to either a power grid (FIG. 7) where available to capacitors for storage for future local use where interconnectivity to a power grid is not available.

Where there is an interconnection to a power grid (FIG. 7), a regulator (FIG. 5) is installed to receive energy from the net meter and grid when other energy levels fall below predetermined levels and where energy is needed to be supplied from the grid to the regulator and rheostat (FIG. 4) which powers the airflow generating device (FIG. 3B).

FIG. 8 shows a plurality of capacitors which can store net energy generating by the wind generators (FIGS. 3C), particularly where the unit is a stand alone one and where there is no interconnection to a power grid to receive the net energy for use by the power grid.

### DRAWINGS—REFERENCE NUMERALS

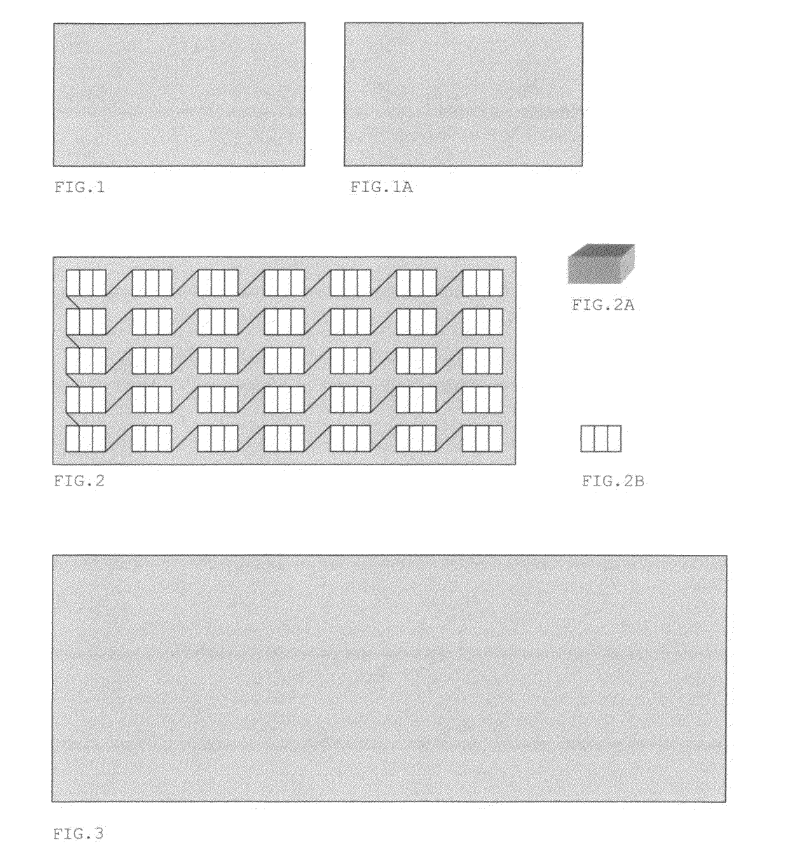

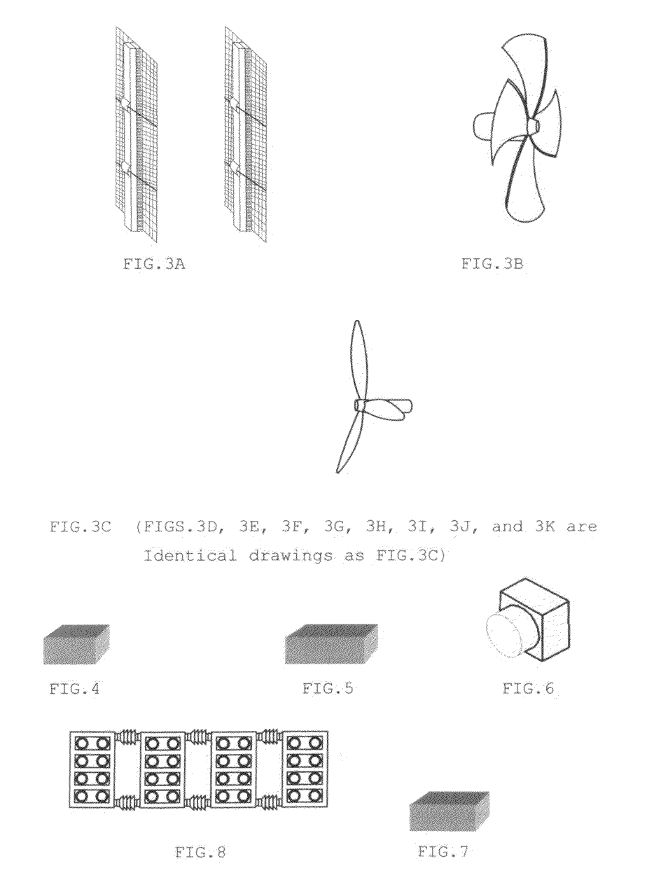

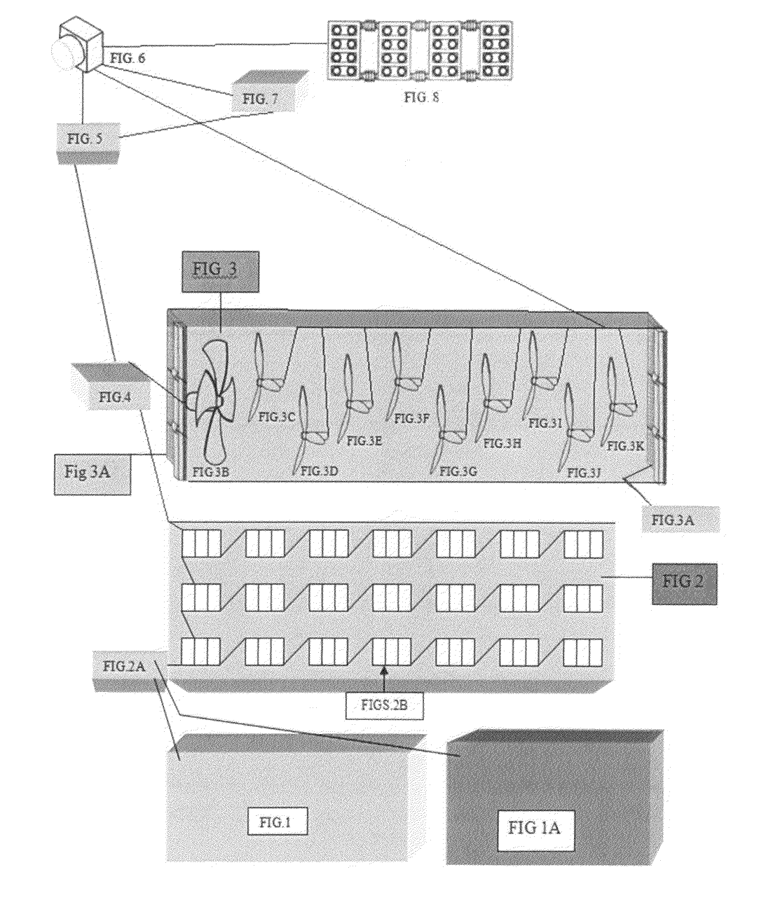

1 FIG. 1—Primary Independent External Source of Energy
2 FIG. 1A—Secondary Independent External Source(s) of Energy
3 FIG. 2—Battery Grid
4 FIG. 2A—Electronic Controller for power input to battery grid
5 FIGS. 2B—Batteries contained in battery grid
6 FIG. 3—Enclosure for the airflow generating device and wind generators
7 FIGS. 3A—Screens for the open ends of the enclosure with a surface brushing device to keep the enclosure ends free of obstructions or debris
8 FIG. 3B—Airflow generating device
9 FIGS. 3C-3K—Plurality of wind generators
10 FIG. 4—Electrical Regulator and Rheostat
11 FIG. 5—Electrical Regulator to receive current when the net meter detects the need for power to be supplied from the power grid to provide an auxiliary source of power to operate the airflow generating device (FIG. 8).
12 FIG. 6—Net Meter
13 FIG. 7—Interconnection to a Power Grid
14 FIG. 8—Capacitors for energy storage when a power grid is not available

### DETAILED DESCRIPTION—FIGS. 1, 2, 3, 4, 5, 6, 7 AND 8,—PREFERRED EMBODIMENT

A preferred embodiment of the energy generating capability of the present invention is illustrated by the combination of FIGS. 1-8 on page 1/3 of the Figures drawings. FIG. 1 is the external source of energy which provides power to operate FIG. 3B, the airflow generating device (e.g.: an electric fan creating a strong airflow.) This source of energy can be any source of energy (mechanical or electrical current energy) that can produce the power necessary to supply sufficient energy to said airflow generating device (FIG. 3B) in order for it to create airflow speeds that are predetermined to be optimal for the operation of FIGS. 3C to 3K, which represent a plurality of wind generators.

FIG. 2 is the battery grid unit, which consists of an enclosure which can be made waterproof containing battery units which are charged by the wind generators and which provide power to drive the wind generating device (FIG. 3B). The battery unit (FIG. 2) is charged by the external power source(s) (FIG. 1 and FIG. 1A) and supplies energy to activate and operate the airflow generating device (FIG. 3B).

FIG. 2A is an electronic controller to which all external sources of energy (FIG. 1) are connected. This controller permits the primary external source to provide power to charge the battery grid consisting of 1 or more batteries (FIG. 2B). If the primary external energy source (FIG. 1) fails to provide sufficient power to charge the batteries, this controller (FIG. 2A) switches to secondary source(s) of power (FIG. 1A) (such as hydrogen cell powered generator, water or steam powered generator, fossil fuel powered generator, or other energy sources) to provide power to charge the battery grid (FIG. 2B).

FIG. 3 is the enclosure that contains the airflow generating device (FIG. 3B) and the plurality of wind generators that produce energy (FIGS. 3C-3K). This enclosure can be cylindrical and can narrow in width from the end where the airflow generating device is located to the opposite end in order to produce the venturi effect which increases the density and concentration of the airflow and assists in maintaining optimal airflow and pressure within the enclosure to drive the plurality of wind generators (FIGS. 3C-3K). FIG. 3A are flat screens which allow for the free flow of air, but which prevent objects from entering the enclosure (FIG. 3).

FIG. 3A each have a surface sweeping device that sweeps across the surface of the screen periodically to brush away any object that adheres to the screen due to the force of incoming air suction or otherwise causes an obstruction of the airflow.

FIG. 3B is an airflow generating device, e.g.: an electrical fan or wind turbine, which creates a strong airflow through the enclosure (FIG. 3) and is calibrated to produce airflow speeds that are optimal speeds and airflow volume to produce the maximum output of energy from the plurality of wind generators (FIGS. 3C-3K) situated in the enclosure (FIG. 3).

FIGS. 3C-3K represent a plurality of wind generators which are placed within the enclosure (FIG. 3) and which are situated so that they are facing the airflow generating device (FIG. 3B). These wind generators are powered by the airflow produced by the airflow generating device (FIG. 3B).

The size and other dimensions of the enclosure (FIG. 3) can be modified to contain larger or smaller wind generating devices, and more or fewer wind generators (represented by FIGS. 3C-3K). These factors are predetermined by the site for the invention, the space available to situate the invention, the amount of energy that is generated from FIG. 1 which predetermines in part the number of wind generators that can be powered, the availability of other back-up renewable and non-renewable sources of energy to power the airflow generating device (FIG. 3B), and the availability of a connection to a power grid from which power can be drawn when the power generated by FIG. 1 may fall below adequate amounts to adequately power the airflow generating device (FIG. 3B).

The procedure for determining the number of wind generators that are placed in the enclosure (FIG. 3) is to predetermine the maximum power output from the external power source, the maximum battery capacity that can be maintained at an adequate charge level by this external power source (FIG. 1), the maximum sustained airflow speeds that can be generated by the airflow generating device (FIG. 3B), and the maximum number of wind generators that can be situated and powered by this airflow within the enclosure in order to attain the maximum output of power from the unit.

The airflow generating device (FIG. 3B) may also be powered by mechanical energy directly from the external power source (FIG. 1), such as water flow, steam flow, or other mechanical energy source which causes the rotation of this device (FIG. 3B) which produces airflow to power the plurality of wind generators (FIGS. 3C-3K).

The source of energy (mechanical or electrical current) is predetermined by the highest output of power available at the site of the installation of the invention, as well as the constancy of the source of this energy.

FIG. 4 is an electrical regulator and rheostat that controls the electrical current that is supplied to the airflow generating device (FIG. 3B). The rheostat component permits electrical current at a predetermined level which controls the speed of the airflow generating device (FIG. 3B). This preset level is set at the optimal speed for energy production by the wind generators (FIGS. 3C-3K). This regulator and rheostat allows current at this level and prevents the electrical current from exceeding this level in order to prevent damage to the wind generators from excessive airflow speed.

FIG. 6 is a net meter device provided by or in agreement with an entity that provides interconnectivity with that entity's power grid. The net meter accounts for the production of electricity produced by the invention. When more electricity is produced from the wind generators (FIGS. 3C-3K) than consumed by the consumer unit (home, business, or other power consuming entity), then the extra energy is fed into the utility grid (FIG. 7) providing that the consumer unit is connected to a utility grid. If the consumer unit is not connected to a utility grid, then there would be no connection to such grid (FIG. 7), but rather there would be a connection to capacitors (FIG. 8) where energy would be stored for future use as needed. Net production of power is thus supplied either to the power grid (FIG. 7) if available, or to capacitors for storage for future use if there is no power grid to connect to.

When less electricity is produced from the wind generators (FIGS. 3C-3K), and when back-up sources of energy connected to the electronic controller (FIG. 2A), if any, fail to compensate adequately for the demand for electricity to power the airflow generating device (FIG. 3B) at the lowest adequate level for producing airflow, then the net meter provides for power to be drawn from the power grid (FIG. 7), pursuant to the proper functioning of a net meter, which then flows to a regulator (FIG. 5) which then supplies power at a preset electrical current level to the power regulator and rheostat (FIG. 4) to provide for continued adequate supply of electrical current to power the airflow generating device (FIG. 3B).

### Operation—FIGS. 1, 2, 3, 4, 5, 6, 7, 8

Energy is generated by the present invention initially by the independent external energy source(s) (FIG. 1, FIG. 1A). Sources of energy that generate mechanical energy supply this energy directly to operate the airflow generating device (FIG. 3B), which in turn provides an airflow that activates the plurality of wind generators Sources of energy that generate electrical current (FIGS. 1 and 1A) supply this current to the battery grid (FIG. 2) and charge the batteries in the grid. The battery grid in turn supplies electrical current to operate the airflow generating device (FIG. 3B). This airflow generating device provides an airflow that activates the plurality of wind generators (FIG. 3C, et al.)

All external sources of energy are connected to the electronic controller (FIG. 2A). This controller provides for the external source of energy which is designated as the primary external source to supply current to charge the batteries (FIG. 2B) in the battery grid. This controller provides for alternative, secondary external sources of energy to be connected and to supply current to charge the batteries when the primary external source fails to provide sufficient preset current volume.

The battery grid provides electrical current to operate the airflow generating device (FIG. 3B) in the enclosure (FIG. 3). The current first flows to the electronic controller and rheostat (FIG. 4), which provides for current to be maintained at predetermined levels so that the airflow generating device provides an airflow at predetermined air speeds and volume. This airflow activates the wind generators (FIG. 3C) that are situated in the enclosure (FIG. 3) in such locations as to optimize the capability of the airflow to activate the wind generators contained in the enclosure. The function of this controller is important primarily in maintaining optimal airflow speeds. Output of energy from a wind generator increases exponentially (by a power of 3 (cubed),) as the airflow speed increases. Therefore, in order to provide maximum energy production by the invention, the airflow speed is preset to be the maximum speed pursuant to the design of the wind generators in the enclosure. The wind generators produce this exponentially increased volume of energy at this optimal airflow speed.

At each end of the enclosure, there are screens (FIG. 3A) which prevent debris from entering the enclosure, and which are periodically swept by surface brushing devices to remove debris or other obstructions which may become lodged on the screen and obstruct the flow of air into the enclosure.

The energy produced by the wind generators in the enclosure flows first to the net meter device (FIG. 6) which provides interconnectivity to an external power grid where available. The net meter accounts for the production of electricity produced by the invention. When more electricity is produced from the wind generators (FIG. 3C) than consumed by the consumer unit (home, business, or other power consuming entity), then the extra energy is fed into the utility grid (FIG. 7) providing that the consumer unit is connected to a utility grid. If the consumer unit is not connected to a utility grid, then there is a connection to capacitors (FIG. 8) where energy is stored for future use as needed. Net production of power is thus supplied either to the power grid (FIG. 7) if available, or to capacitors for storage for future use if there is no power grid to connect to.

When less electricity is produced from the wind generators (FIGS. 3C-3K), and when back-up sources of energy connected to the electronic controller (FIG. 2A), if any, fail to compensate adequately for the demand for electricity to power the airflow generating device (FIG. 3B) at the lowest adequate level for producing airflow, then the net meter provides for power to be drawn from the power grid (FIG. 7), pursuant to the proper functioning of a net meter, which then flows to a regulator (FIG. 5) which then supplies power at a preset electrical current level to the power regulator and rheostat (FIG. 4) to provide for continued adequate supply of electrical current to power the airflow generating device (FIG. 3B).

### Conclusion, Ramifications and Scope:

Accordingly, the reader will see that an external source or sources of energy charge a grid of batteries which provide a constant and continual source of power by which to activate and operate an airflow generating device in an enclosure. This solves the primary problem regarding wind energy production, which is the unpredictability and intermittency of wind speeds that occur naturally in the environment, by providing a constant, continual and optimal airflow by which to generate wind/airflow power. A plurality of wind generators are placed in this enclosure and are powered by this airflow at optimal air speeds and volume, thus producing large amounts of wind/airflow energy primarily in the form of electrical current. Further ramifications include the following:
The sources of external power are localized, such as solar panels or photovoltaic cells installed at the same location as the enclosure, rather than dependent upon a remote power grid.
The power generating unit can be placed virtually anywhere in relatively small spaces, and produce large amounts of wind/airflow energy power often in much greater volume than needed by the location of the unit, which in turn allows the unit to contribute this extra power to a power grid for use in other locations where needed or to be stored in capacitors for future use.
The power generating units produce their own airflow and are not dependent on the presence of and intermittency of airflow speeds and volume that occur naturally in the environment
The power generating units are flexible regarding secondary and auxiliary sources of energy that can be made available to power the airflow generating device in the event that the primary source of energy may be temporarily inadequate.
The power generating units can be made small and compact enough to power land vehicles, and can also power air and aquatic vehicles.
The power generating units use renewable sources of energy, thus reducing with the objective of eliminating use of and dependence on non-renewable sources of energy such as fossil fuels.
The power generating units have virtually no negative impact on the environment, they have positive effects on the environment by improving air and water quality and eliminating pollutants from the power plants which they replace, they conserve natural resources and provide a way to produce energy more efficiently, and other positive environmental effects.
The power generating units assist in the efforts to combat terrorism by eliminating dependence on foreign sources of energy, including from terrorist nations, by de-centralizing power production thus lessening the effects of terrorist attacks on larger power plants which presently exist, by providing an alternative to nuclear energy thus eliminating the need for production of nuclear fuel and wastes which can be the source of production of nuclear fuels for nuclear weaponry, and by eliminating the present vast sums of funds paid to nations including terrorist nations, who use such funds to sponsor terrorism.

The ramifications and scope of the invention are highly significant, particularly in providing low cost, renewable sources of energy, providing for energy independence for our nation and eliminating dependence on foreign sources for energy production, and the effort to combat terrorism.

I claim:

1. An energy generating unit wherein an external source or sources of energy charge a battery grid unit which provides power to and activates an airflow generating device in an enclosure to produce an air flow in the enclosure which activates a plurality of wind generators in the enclosure which is open directly behind the airflow generating device in order to draw air into the enclosure and which is open at the other end of the enclosure to permit the airflow to exit the enclosure with protective screens on each end which prevent debris from entering the unit and with surface brushing devices which sweep over the screens periodically by which to clear the screens of obstructions whereby a constant and reliable airflow is generated in an enclosure by which to provide consistent operation of said wind generators at optimal air speeds to generate optimal volume of energy production.

2. A method for predetermining the optimal airflow speed produced by the airflow generating device in claim 1, the size and dimensions of the enclosure in claim 1, and the number of wind generators in claim 1 that can be situated in the enclosure which can be operated at optimal airflow speeds, wherein said factors are predetermined by ascertaining the constant average output of the external source or sources of energy, the maximum level of battery capacity which can be charged by the external energy source or sources, the airflow speed and volume that can be generated by the airflow generating device and maintained based on the power output from the battery grid, the specifications and requirements for adequate and optimal operation of wind generators placed in the enclosure, and the dimensions of the site where these devices can be placed. The dimensions of the enclosure and the maximum number of wind generators placed in the enclosure is the number that can be operated adequately within the enclosure based on predetermination of these factors and site factors where the unit is placed.

3. A method regarding the use of mechanical energy as an external source of energy for predetermining the optimal airflow speed produced by the airflow generating device in claim 1, the size and dimensions of the enclosure in claim 1, and the number of wind generators in claim 1 that can be situated in the enclosure which can be operated at optimal airflow speeds, wherein said factors are predetermined by ascertaining the constant average output of mechanical energy which can operate the airflow generating device to produce the maximum constant airflow speed and volume and the specifications and requirements for adequate and optimal operation of wind generators placed in the enclosure, and the dimensions of the site where these devices can be placed. The number of wind generators placed in the enclosure is the maximum number that can be operated adequately within the enclosure based on predetermination of these factors and site factors where the unit is placed.

4. A constant and reliable source of power to drive the airflow generating device in claim 1 which is provided by the battery grid which is kept adequately charged by the external source or sources of power.

5. A connection of the energy generating device in claim 1 to a net meter by which to supply excess power generated by the device to a power grid.

6. Auxiliary sources of energy in claim 1 that can provide power to the airflow generating device if the battery grid should fall below capacity to adequately maintain the airflow speed and volume. Such sources may include power supplied from a net meter.

7. A source of energy from energy generating devices as defined in claim 1 for mobile objects and vehicles including land, air and aquatic vehicles of all types and classes.

8. Sufficiently compact energy generating devices in claim 2 which provide the power source for land vehicles of all sizes and classes.

9. Energy generating devices in claim 2 which are powered by different capacities and sizes of battery grid units according to predetermined space requirements and limitations.

10. Energy generating devices in claim 2 that power mobile land vehicle whose battery grids can be recharged as needed by stationary energy generating devices as defined in claim 1 which are placed beside roadways and other locations which are made accessible to the mobile units.

11. Energy generating devices in claim 2 which provide the energy source for aircraft and are sufficiently compact for providing energy for operation of aircraft of all sizes and classes.

12. Energy generating devices in claim 2 which provide the energy source for aquatic vehicles that do not require units that are as compact as those which power land and air vehicles.

13. Interconnection to a power grid or grids of energy generating devices defined in claim 1 where said devices which produce excess power can supply this power to the grid for use in other locations where power is needed and where the power grid can supply power to any energy generating device which may need from time to time a supply of energy.

14. A worldwide network of power grids to supply energy from said energy generating devices throughout the world.
